(19) United States
(12) Patent Application Publication
(10) Pub. No.: US 2026/0119254 A1
(43) Pub. Date: Apr. 30, 2026

(54) EXECUTION OF APPLICATION BASED ON STATELESS TASKS

(71) Applicant: Nokia Solutions and Networks Oy, Espoo (FI)

(72) Inventor: Utku Gunay ACER, Antwerp (BE)

(21) Appl. No.: 19/365,817

(22) Filed: Oct. 22, 2025

(30) Foreign Application Priority Data
Oct. 28, 2024 (FI) 20246275

(51) Int. Cl. G06F 9/50

(52) U.S. Cl. CPC G06F 9/5027

(57) ABSTRACT

A computing device comprising: at least one processor; at least one memory; an operating system configured to load, in the at least one memory, instances of a plurality of applications and a plurality of stateless tasks for execution by the at least one processor of the computing device; wherein at least one application of the plurality of applications is defined based on a temporal sequence of stateless tasks and is configured to request an execution of each stateless task in the temporal sequence, wherein each of the stateless task in the temporal sequence is configured to be executed based on application-specific data which are transmitted to and/or received from the considered stateless task by inter-process communication involving the application and the stateless task.

### TECHNICAL FIELD

Various example embodiments relate generally to a computing device for executing applications based on stateless tasks and a corresponding method.

### BACKGROUND

Embedded, resource constrained computing devices cannot run traditional Operating Systems (OS). They typically leverage Real Time Operating Systems (RTOS) that support lightweight applications. While there has been great progress in software running in such resource constrained computing devices lately, it is still much slower pace than software running on the cloud with paradigms such as serverless computing, microservices, etc., providing agile and scalable solutions to multi-user, multi-tenant systems by facilitating component re-use. These paradigms are powered by virtualization technology, like containers and Virtual Machines. However, virtualization cannot be deployed on resource constrained computing devices as it depends on complex operating systems and large resources, memory in particular.

There is need to provide a virtualization solution adapted for resource constrained computing devices.

### SUMMARY

The scope of protection is set out by the appended claims. The embodiments, examples and features, if any, described in this specification that do not fall under the scope of protection are to be interpreted as examples useful for understanding the various embodiments or examples that fall under the scope of protection.

According to a first aspect, a computing device comprises: at least one processor; at least one memory; an operating system configured to load, in the at least one memory, instances of a plurality of applications and a plurality of stateless tasks for execution by the at least one processor of the computing device; wherein at least one application of the plurality of applications is defined based on a temporal sequence of stateless tasks and is configured to request an execution of each stateless task in the temporal sequence, wherein each of the stateless task in the temporal sequence is configured to be executed on request from the application based on application-specific data which are transmitted to and/or received from the considered stateless task by inter-process communication involving the application and the stateless task.

Each loaded instance of a stateless task may be configured to receive and process execution requests from multiple applications and to use respective application-specific data specific to the requesting application for its execution.

The operating system may be configured to load only one instance of each of the plurality of stateless tasks.

The operating system may be configured to allocate respective application-specific memory spaces to the plurality of applications.

The application-specific data may be stored in an application-specific memory space which is specific to the application.

The operating system may be configured to allocate compute resources to the stateless tasks on an as-used basis.

The operating system may be configured to control execution of the plurality of stateless tasks to prevent concurrent executions of a given stateless task requested by two or more distinct applications.

The operating system may be configured to control execution of the plurality of stateless tasks to prevent concurrent execution of a given stateless task requested by two or more applications by using a request queue adapted for storing execution requests sent to the given stateless task by any of the applications.

For its execution on request from a given application, at least one of the stateless tasks may be configured to receive application-specific task input data or application-specific task parameters from the application by inter-process communication.

For its execution on request from a given application, at least one of the stateless tasks may be configured to provide application-specific task output data to the application by inter-process communication.

A stateless task in the temporal sequence may be configured to receive, from the application, an access key providing access to a portion of the application-specific memory space of the application.

A stateless task may be configured to receive, from the application, an address of a portion of the application-specific memory space of the application where the application-specific task input data or application-specific task parameters to be used by the stateless task for the execution of the application are stored. The stateless task may be configured to retrieve the application-specific task input data or application-specific task parameters from the portion of the application-specific memory space during its execution.

The stateless task may be configured to receive, from the application, an address of a portion of the application-specific memory space of the application where the application-specific task output data generated by the stateless task for the execution of the application are to be stored. The stateless task may be configured to store the application-specific task output data to the portion of the application-specific memory space during its execution.

The access key may be an authentication key configured to authenticate the stateless task.

The computing device may be a resource constraint computing device.

According to a second aspect, a method for executing one or more applications by a computing device is disclosed. The method comprises: loading, by an operating system of the computing device, in at least one memory of the computing device, instances of the one or more applications and a plurality of stateless tasks for execution by the at least one processor of the computing device, wherein at least one of the plurality of applications is defined based on a temporal sequence of stateless tasks among the plurality of stateless tasks; requesting by the application an execution of each stateless task in the temporal sequence; performing by the application at least one of: (i) transmitting to at least one stateless task application-specific task input data by inter-process communication involving the at least one stateless task and (ii) receiving from the at least one stateless task application-specific task output data by inter-process communication involving the at least one stateless task.

According to another aspect, a computing device comprises means for performing one or more or all steps of any method disclosed herein. The means may for example include at least one processor and at least one memory storing instructions that, when executed by the at least one processor, cause the computing device to perform one or more or all steps of any method disclosed herein. The means may for example include circuitry (e.g., processing circuitry) configured to perform one or more or all steps of any method disclosed herein.

According to another aspect, a computer program comprises instructions that, when executed by an computing device, cause the computing device to perform: loading, by an operating system of the computing device, in at least one memory of the computing device, instances of the one or more applications and a plurality of stateless tasks for execution by the at least one processor of the computing device, wherein at least one of the plurality of applications is defined based on a temporal sequence of stateless tasks among the plurality of stateless tasks; requesting by the application an execution of each stateless task in the temporal sequence; performing by the application at least one of: (i) transmitting to at least one stateless task application-specific task input data by inter-process communication involving the at least one stateless task and (ii) receiving from the at least one stateless task application-specific task output data by inter-process communication involving the at least one stateless task. The instructions may cause the computing device to perform one or more or all steps of any method disclosed herein.

According to another aspect, a non-transitory computer readable medium comprises computer program instructions stored thereon for causing a computing device to perform at least the following: loading, by an operating system of the computing device, in at least one memory of the computing device, instances of the one or more applications and a plurality of stateless tasks for execution by the at least one processor of the computing device, wherein at least one of the plurality of applications is defined based on a temporal sequence of stateless tasks among the plurality of stateless tasks; requesting by the application an execution of each stateless task in the temporal sequence; performing by the application at least one of: (i) transmitting to at least one stateless task application-specific task input data by inter-process communication involving the at least one stateless task and (ii) receiving from the at least one stateless task application-specific task output data by inter-process communication involving the at least one stateless task. The computer program instructions may cause the computing device to perform one or more or all steps of any method disclosed herein.

### BRIEF DESCRIPTION OF THE DRAWINGS

Example embodiments will be more fully understood from the detailed description given herein below and the accompanying drawings, which are given by way of illustration only and thus are not limiting of this disclosure.

FIG. 1 is a schematic diagram illustrating an execution of an application and a plurality of stateless tasks by a computing device according to an example.

FIG. 2 is a schematic diagram illustrating an execution of an application and a plurality of stateless tasks by a computing device according to an example.

FIG. 3 is a schematic diagram illustrating inter-process communication involving an application and a stateless task according to an example.

FIG. 4 is a schematic diagram illustrating inter-process communication involving an application and a stateless task according to an example.

FIG. 5 is a schematic diagram illustrating an execution of an application and a plurality of stateless tasks by two computing devices according to an example.

FIG. 6 is a schematic diagram illustrating an execution of an application and a plurality of stateless tasks by two computing devices according to an example.

FIG. 7A is a flow diagram illustrating a use case according to an example.

FIG. 7B is a flow diagram illustrating a use case according to an example.

FIG. 7C is a flow diagram illustrating a use case according to an example.

FIG. 8 is a flowchart illustrating a method for executing one or more applications using a plurality of stateless tasks according to an example.

FIG. 9 is a flowchart illustrating a method for executing one or more applications using a plurality of stateless tasks according to an example.

FIG. 10 is a block diagram illustrating an exemplary hardware structure of a computing device according to an example.

It should be noted that these drawings are intended to illustrate various aspects of computing devices, methods and structures used in example embodiments described herein. The use of similar or identical reference numbers in the various drawings is intended to indicate the presence of a similar or identical element or feature.

### DETAILED DESCRIPTION

Detailed example embodiments are disclosed herein. However, specific structural and/or functional details disclosed herein are merely representative for purposes of describing example embodiments and providing a clear understanding of the underlying principles. However, these example embodiments may be practiced without these specific details. These example embodiments may be embodied in many alternate forms, with various modifications, and should not be construed as limited to only the embodiments set forth herein. In addition, the figures and descriptions may have been simplified to illustrate elements and/or aspects that are relevant for a clear understanding of the present invention, while eliminating, for purposes of clarity, many other elements that may be well known in the art or not relevant for the understanding of the invention.

Various example embodiments relate generally to a computing device for executing applications and a corresponding method.

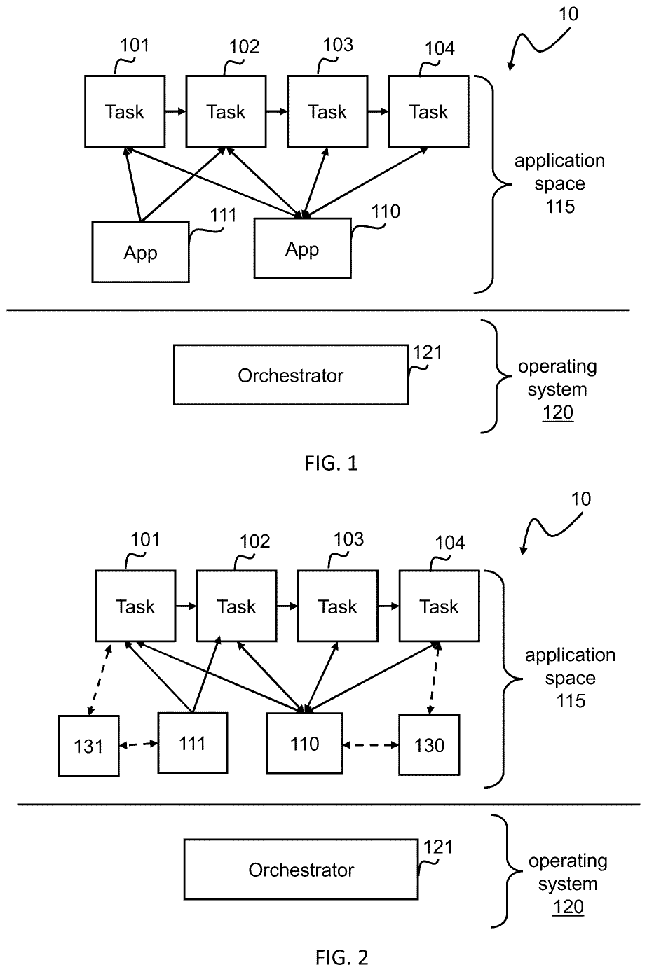

FIG. 1 is a schematic diagram illustrating an execution of an application and a plurality of stateless tasks by a computing device according to an example.

The computing device may be a resource constraint computing device, for example a tiny computing device, an embedded computing device.

The computing device 10 may be configured to execute a plurality of applications 110, 111 and a plurality of stateless tasks 101-104, under control of an operating system 120 of the computing device 10.

The computing device includes at least one processor (not represented) configured to execute the plurality of applications 110, 111 and a plurality of stateless tasks 101-104. The computing device includes at least one memory configured to storing instructions of execute the plurality of applications 110, 111 and a plurality of stateless tasks 101-104 such that, when these instructions are executed by the processor, the instructions cause the computing device to execute the plurality of applications 110, 111 and a plurality of stateless tasks 101-104.

The execution of an application 110, 111 uses one or more of the stateless tasks 101-104 whose execution is requested by the considered application. A function call or an event may be used to request the execution of a stateless task. Various technologies such as REST API (Representational State Transfer Application Programming Interface) or RPC (Remote Procedure Call) may be used for requesting execution of a stateless task by an application based on a function call.

An application 110, 111 may be formed by chaining multiple stateless tasks 101-104 together, such that a pipeline of multiple stateless tasks is built. In the pipeline, the output of one task may be provided as an input to the next one in the pipeline. An application 101-104 may thus be defined based on a specific temporal sequence of stateless tasks 101-104 and is configured to request an execution of each stateless task in the temporal sequence.

Each stateless task may correspond to executable code whose execution may be requested by one or more application on an as needed basis. A stateless task may be defined as a task that does not retain any data that may persist from one execution to another.

Each stateless task may provide a functionality corresponding to an associated function whose execution can be requested by any application, e.g. with task parameters and input/output data that are all specific to the requesting application. This functionality may correspond to a main function executed by the task. This main function may require arguments, including for example input data and/or output data and/or task parameters.

For example, as illustrated by the simplified software code below, a task may execute a main function “execute main function” that may require arguments (e.g., input data, output data, task parameters). An execution request received by the task may include such arguments.

The main function may itself call sub-functions “execute sub function!”. “execute sub function1” that can be called by the main function but not externally by an application. Any execution request to this task triggers the execution of main function

```
“execute_main_function”.
  void execute_sub_function1( )
  {
    ...
  }
  void execute_sub_function2( )
  {
    ...
  }
  void execute_main_function( )
  {
      execute_sub_function1( );
      execute_sub_function2( );
  }
```

The execution of a stateless task is performed based on application-specific data used as arguments of the main function. For example, the application-specific task input data are transmitted to the stateless task or application-specific task output data are received by the application from a stateless task.

The application-specific data, used for a given stateless task whose execution is requested by a given application, may include:
task parameters, referred to as the application-specific task parameters: these task parameters are used to configure parameters of the main function performed by the task;
input data for the task, referred to as the application-specific task input data: these input data are provided as input data of the main function performed by the task;
output data for the task, referred to as the application-specific task output data: these output data are output data of the main function performed by the task.

In embodiments, only one instance of each of the plurality of stateless tasks is loaded for execution by the computing device.

Each newly loaded instance of a stateless task is configured to wait for an execution request before starting the execution of the main function of the task and is referred to as a requestable instance. Every execution request to the stateless task triggers the execution of the main function of the task.

In embodiments, concurrent executions of the main function of a stateless task are prevented when the stateless task is requested by two or more applications.

This may be done for example by using a request queue for a stateless task, this request queue being adapted for storing execution requests from several applications such that the main function of the stateless task will be executed successively based on the order of the execution requests in the request queue, and using each time the application-specific data which is specific to the application 110 having sent the execution request being processed. The operating system 120 may be configured to control sending of the execution requests from the request queue to the stateless task.

This may be done for example by using in the task code, a main task loop to continuously check if there is any unprocessed request in the request queue. If that is the case, the first unprocessed request in the request queue is used to trigger the main function of the task. When function arguments are required by the main function, each unprocessed request in the request queue may include the function arguments (input data and/or output data and/or task parameters). If an application-specific data store is used, then the unprocessed requests in the request queue may include access key that the task can use to fetch to the function arguments from the application-specific data store.

The application-specific data used as arguments of the main function are transmitted using inter-process communication involving the considered application and the stateless task(s).

Inter-process communication (IPC) refers to mechanisms that allow processes (e.g., applications and tasks) to communicate with each other, for example to synchronize their actions and share data. Since processes may run in different memory spaces, IPC provides the means to share data and send signals between them. Example IPC methods include:

Pipes: Used for one-way communication, allowing data to flow from one process to another.

Message Queues or message passing: Allow processes to send and receive messages in a queued manner, facilitating asynchronous communication.

Shared Memory: A memory segment accessible by multiple processes, enabling fast data sharing.

Remote Procedure Call (RPC) is another way to implement inter-process communication (IPC). RPC allows a program to execute a procedure (or function) in a different address space, which could be on the same machine or on a remote server. This abstraction simplifies the complexity of communication between processes, allows to call functions as if they were local, using an underlying communication system. The stateless tasks may communicate with each other directly or via the application. In embodiments, message passing for communication with the stateless tasks. For example, for the execution of a given application 110, at least one of the stateless tasks which is used by the application 110 receives application-specific task input data and/or application-specific task parameters by message passing from the considered application 110. Likewise, for the execution of a given application 110, at least one of the stateless tasks used by the considered application 110 produces application-specific task output data and provides the application-specific task output data by message passing to the considered application 110.

The stateless tasks 101-104 may be compared to virtualized functions in serverless computing. A virtualization is achieved, here not through code execution isolation, but merely through data isolation in a way that allows executable code re-use at execution time by multiple applications. To achieve this, each stateless task (i.e. the code, of the stateless tasks, including the executable code and source code) is configured to receive and process execution requests from multiple applications based on application-specific data specific to the requesting application. Each stateless task is configured to use as input application-specific data specific to the requesting application for its execution and to generate application-specific data specific to the requesting application as output. Each stateless task is configured to be executed without reusing the application-specific data for any next execution of the stateless task.

The stateless tasks do not provide any information from an application to the other applications. Each task to be executed is configured based on application-specific data and is not allowed to share this application-specific data with other tasks or other applications. No stateless task can infer any knowledge from a first output, generated when the task is executed on request from an application, about a second output generated when the task is executed on request from another application.

The output data of an intermediate task in a temporal sequence of stateless tasks is transient and is not stored by this intermediate task. Instead, these output data may be provided to the next task in the sequence by inter-process communication (e.g., message passing) involving the requesting application, the intermediate task and the next task. The output data of the last task in a temporal sequence of stateless tasks provided to the requesting application for generation of an outcome of the requesting application.

In the computing device 10, the operating system 120 is configured to load in memory, instances of one or more applications and a plurality of stateless tasks for execution by the computing system.

FIG. 2 is a schematic diagram illustrating an execution of an application and a plurality of stateless tasks by a computing device according to an example in which an application-specific data store is implemented in an application-specific memory space.

The application-specific data store may be used for storing all the application-specific data needed as input or task parameters or produced as output by the stateless tasks during their execution in response to a request from the considered application.

In embodiments, as illustrated by FIG. 2, the operating system 120 may be configured to allocate, in a memory space, a respective application-specific memory space 130, 131 to each application 110, 111. An application-specific memory space 130 is configured to store application-specific data which is specific to the application 110 and is referred to as an application-specific data store. The application-specific memory space 130 allocated to an application 110 and the application-specific data stored therein cannot be accessed by the other applications 111 and is private to the application 110.

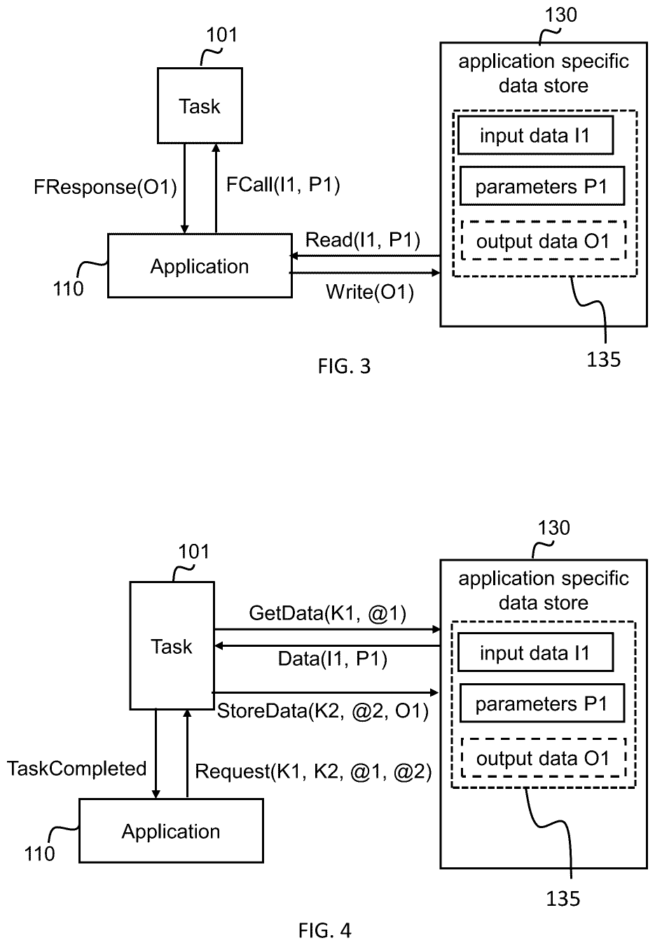

FIG. 3 is a schematic diagram illustrating inter-process communication involving an application and a stateless task according to an example.

In this example, an application-specific data store 130 is allocated to the application and is configured to store application-specific task input data I1, P1, O1, where I1 are application-specific task input data, P1 are application-specific task parameters and O1 are application-specific task output data.

The application-specific data store 130 can be accessed only by application 110 but not by the task 101.

The application 110 uses inter-process communication to provide application-specific data to the task 101 and receive application-specific data from the task 101.

In this example, the application sends a request for execution of a task 101 using a remote procedure call “FCall (I1, P1)” including I1 and P1 as arguments. In response, when the task execution is completed, the task 101 responds to the application 110 with a remote procedure call “FResponse (O1)” including O1 as arguments.

In embodiments, the application-specific memory space 130 allocated to an application 110 may be accessed by one or more tasks. To secure the application-specific memory spaces 130, 131, cryptographic keys may be used as encryption keys for encrypting the data stored in the application-specific memory spaces 130, 131. To secure the application-specific memory spaces 130, 131, cryptographic keys may be used as access keys for providing to a stateless task access to a portion 135 of (i.e. not all of) the application-specific memory space. An access key may be used as authentication key for authenticating a stateless task to which access is provided to a portion 135 of the application-specific memory space.

For example, when an application-specific data store is used, the data it maintains needs be encrypted such that the data used by one task remains isolated from those used by another task and such that only those other tasks that are allowed to access a given subset of the data receives (i) an address to access to the given subset and (ii) an encryption key that allows to decrypt the stored subset.

In embodiments, the application-specific memory space 130 allocated to an application 110 may be accessed by one or more tasks 101 which may be configured to receive, from the application 110, an address of a portion 135 of the application-specific data store of the application 110 where the input data and/or task parameters to be used by the stateless task 101 for the execution of the application 110 are stored.

In embodiments, the application-specific memory space 130 allocated to an application 110 may be accessed by one or more tasks 101 which may be configured to receive, from the application 110, an address of a portion 135 of the application-specific memory space of the application 110 where the output data generated by the stateless task 101 for the execution of the application are to be stored 110.

FIG. 4 is a schematic diagram illustrating inter-process communication involving an application and a stateless task according to an example.

In this example, an application-specific data store 130 is allocated to the application and is configured to store application-specific task input data I1, P1, O1, where I1 are application-specific task input data, P1 are application-specific task parameters and O1 are application-specific task output data.

The application-specific data store 130 can be accessed by application 110 and also by the task 101.

The application 110 uses inter-process communication to provide application-specific data to the task 101 and receive application-specific data from the task 101.

In this example, the application 110 sends a request for execution of a task 101 using a remote procedure call “Request (K1, K2, @1, @2)” including K1, K2, @1, @2 as arguments where: K1 is a first access key for accessing to I1 and P1 stored at address @1 in the application-specific data store 130, K2 is a second access key for storing O1 at address @2 in the application-specific data store 130. The task 101 get the input data I1 and the application-specific task parameters P1 by sending a request “GetData (K1, @1)” to retrieve I1 and P1 from the application-specific data store 130. When the task execution is completed, the task 101 stores the output data O1 at address @2 using K2 as access key. The task 101 responds to the application 110, e.g., with a remote procedure call “TaskCompleted ( ) to inform the application of the completion of the task. The application 110 may access to the output data O1 stored in the application-specific data store 130 by task 101.

In embodiments, multiple computing devices may be used to carry out an application. In this case, each of the computing devices may execute one or more of the stateless tasks of the temporal sequence of tasks defined for the application. In this case, the execution requests to target stateless tasks may be sent through communication interfaces (e.g., network interface) of the computing devices, if the target stateless task is executed on a computing device distinct from the computing device on which the application is executed.

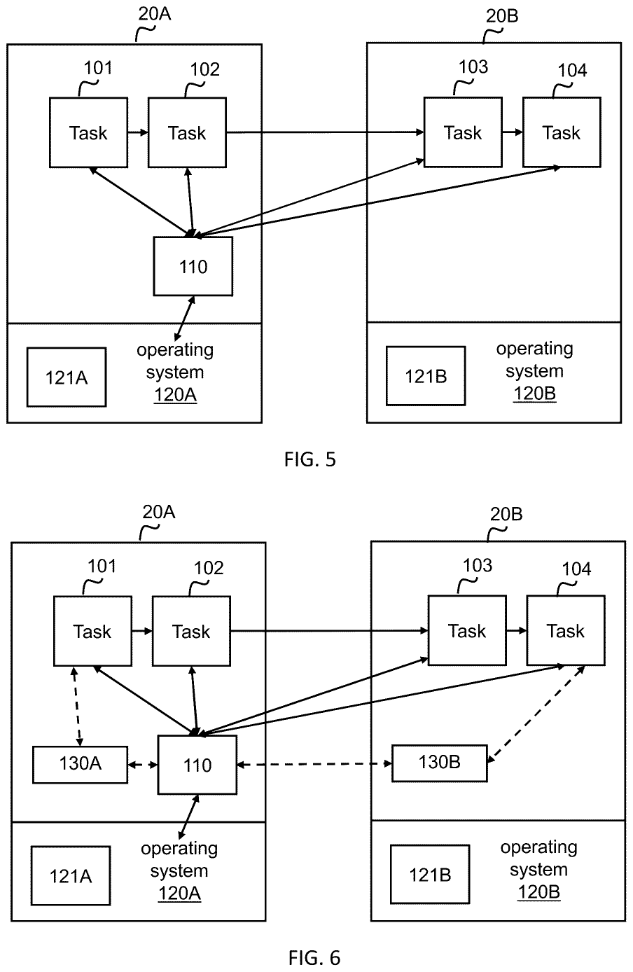

FIGS. 5 and 6 are schematic diagrams illustrating an execution of an application 110 and a plurality of stateless tasks 101-104 by two computing devices 20A, 20B according to examples, with and without application-specific data stores 130A, 130B. These examples are limited to two computing devices for the sake of simplicity, but any number of computing devices may be used.

In these examples, the application 110 is executed on the computing device 20A. A temporal sequence of tasks 101-104 is defined for the application, among which tasks 101-102 are executed on computing device 20A while tasks 103-104 are executed on computing device 20B.

As illustrated by FIG. 6, one or more or each of computing devices 20A, 20B may host a respective application-specific data stores 130A, 130B for a given application 110. An application-specific data store on a given computing device 20A may be used to store application-specific data (e.g., application-specific task input data, application-specific task output data, and application-specific task parameters) of a considered application 110 executed by this given computing device 20A.

As explained above by reference to FIGS. 3-4, an application-specific data store 130A (respectively 130B) on a given computing device 20A (respectively 20B) may be used to share data between the considered application 110 and the one or more stateless tasks 101-102 (respectively 103-104) executed by the same computing device 20A (respectively 20B) using inter-process communication.

In other embodiments not illustrated by FIGS. 3 and 4, the inter-process communication may be based on a “callback function” that is configured to trigger a next task to execute with the application-specific task output data produced by the previous task in the sequence.

In embodiments, as represented in FIGS. 1 and 2, the operating system of a computing device 10 may be configured with an orchestration function or orchestrator 121.

The orchestrator 121 is a part of the operating system. For each task, the operating system may allocate compute resources and the orchestrator may determine the amount of these compute resources that is needed for each task. The determination may be based on the application-specific data provided by the application for the execution of the stateless tasks and/or given a temporal sequence of stateless task defined for an application. The allocation of the compute resources and determination of the amount may be made on an as-used basis.

For example, given a temporal sequence of stateless task defined for an application, the orchestrator may decide on how to allocate compute resources (e.g. compute time/cycles, memory space, stack, etc.) to each task in the sequence.

In a collaborative system with multiple computing devices as in FIG. 2, the orchestrators in all computing devices may collectively decide how to distribute the tasks across them.

The orchestrator ensures that the tasks that compose an application can communicate with each other or at least receives the application-specific task output data from a previous task by inter-process communication involving the application and the considered tasks as disclosed herein.

When the inter-process communication involves a callback function that prompts the next task, the information to which callback function of the next task the call should be made is given by the orchestrator to the current task.

When an application-specific data store is used, the orchestrator may be configured to allocate memory for the application-specific data store and determines to which portion of memory each task has access. The orchestrator may be configured to generate the encryption keys provided to the concerned tasks such that each task can access to the portion of memory where the application-specific task input data, application-specific task output data and application-specific task parameters are stored for the considered task.

The application developer may not be necessarily same as the task developer. While task developers provide the source code of one or more stateless tasks, an application developer links several stateless tasks together to chain them and offer an end-to-end service. For each stateless task, a document may describe the type of inter-process communication to be used for requesting execution of the considered task. The document may also describe the type of input, the type of output and the main function performed by the stateless task. The type of the input (or output) data may be a single value, an array, or another data type.

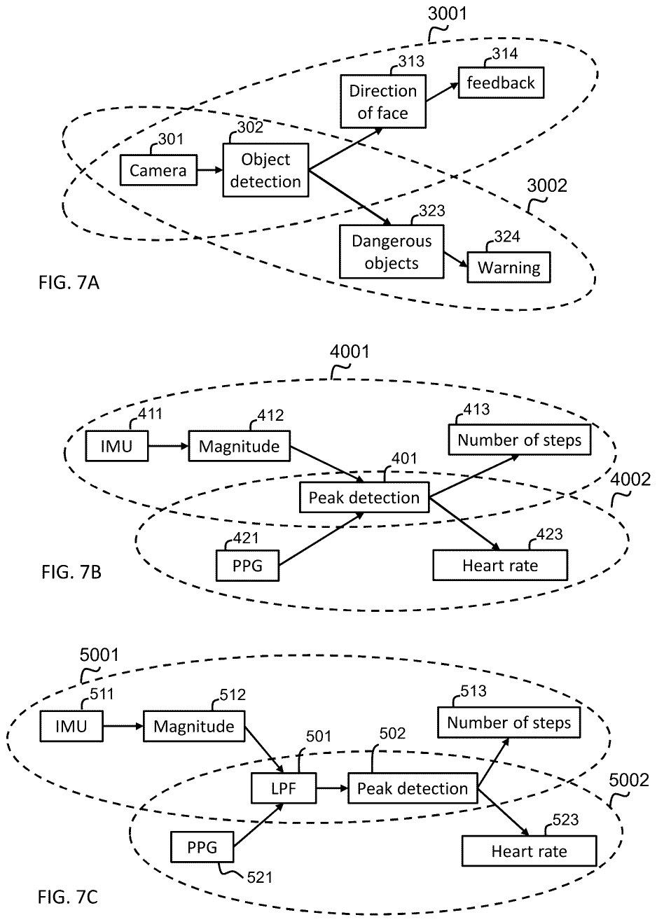

FIGS. 7A-7C are flow diagrams illustrating use cases according to an example.

Two reality assisted applications 3001, 3002 that may run in a smart glass computing device for visually impaired users are illustrated by FIG. 7A.

The example of FIG. 7A illustrate use cases where the output of a task is used by more than one tasks.

The first application 3001 detects the faces of the people who are nearby and notify the user about the direction so that the user can change their direction towards them. The second application 3002 detects objects that may be dangerous and notifies their location to the user to prevent an accident.

The first application 3001 is defined based on a temporal sequence of tasks including tasks 301 (image acquisition by a camera), 302 (object detection in image), 313 (human face direction detection), 314 (haptic feedback) and the second application 3002 is defined based on a temporal sequence of tasks including tasks 301, 302, 323 (dangerous objects detection), 324 (warning generation).

Both applications 3001, 3002 rely on a camera task 301 configured to acquire images by using a camera and an object detection task 302 configured to detect object in images. In traditionally built, black-box, monolithic applications, the computing device needs to perform the same object detection task twice on the same video frame. Instead, the output of the task 301 is provided only once to the task 302 for object detection. The task 302 then performs object detection model to identify and locate various objects in the images. A list of all the objects and their locations is then sent to two subsequent tasks, e.g. tasks 313 and 323 that are responsible for application specific processing regarding the human faces direction detection and dangerous objects detection, respectively. The output of human face direction detection task 313 is then sent to haptic feedback task 314 to provide to the user the direction of the detected face through the touch sensation. Similarly, the output of dangerous objects detection task 323 is given to warning generation 324 to generate an auditory cue about the nearby dangers if any. Using this method, the computing device does not need to implement the object detection model twice.

The example of FIG. 7B illustrate use cases where one task receives input from two different tasks.

The first application 4001 is defined based on a temporal sequence of tasks including tasks 411 (signal acquisition by IMU, Inertial Measurement Unit), 412 (magnitude signal generation), 401 (peak detection), 413 (steps counting) and the second application 3002 is defined based on a temporal sequence of tasks including 421 (PPG acquisition, photoplethysmogram), 401 (peak detection), 413 (heart rate computation).

This is an example with for a computing device configured to count the number of steps a user is taking and his heart rate. Both heart rate and step counting applications rely on peak detection in a signal. In case of step counting, peak detection is performed on the signal from the IMU where for the heart rate, peak detection is performed on the PPG signal. In this case, the sensors IMU 411 and PPG 421 produces waveform data in windows of a given length. For IMU, the task 412 converts three separate signals from the IMU along x,y,z axis into a magnitude signal. Peak detection task 401 is configured to receive signals from both tasks 412 and 421 and is configured to count the number of peaks in the windowed input signal. Peak detection task 401 sends the output (i) to task 413 for step counting and generating a number of steps and (ii) to task 423 for hearth rate detection. Note that the data passed to task 401 in both applications is transient and is not stored in the task. All the data used by either application is isolated from the other application.

Compared to the example of FIG. 7B, the example given in FIG. 7C involves low pass filters for the two applications.

The first application 5001 is defined based on a temporal sequence of tasks including tasks 511 (signal acquisition by IMU), 512 (magnitude signal generation), 501 (low pass filter, LPF), 502 (peak detection), 513 (steps counting) and the second application 3002 is defined based on a temporal sequence of tasks including 521 (PPG signal acquisition), 501 (low pass filter), 502 (peak detection), 523 (heart rate computation).

While the tasks are stateless, the output of the low pass filter task 501 may depend not only on current samples in a current time window but also the previous samples in a previous time window. In addition, the filter coefficients for two applications are likely different. To facilitate this, each of the application-specific data stores of applications 5001 and 5002 may maintain an array of samples provided as output of tasks 512 and 521. To facilitate the convolution operation of the low pass filter, these arrays implement sliding windows for selection of samples to be processed by the low pass filter task 501. In addition, when low pass filter task 501 is to be executed, the low pass filter task 501 may receive the filter coefficients specific to the considered application either from the application-specific data store or from the arguments provided by the application, e.g., by function call. The output of the low pass filter task 501 is then provided to the peak detection task 502. The tasks 513 and 523 are identical to tasks 413 and 423 respectively described by reference to FIG. 7B.

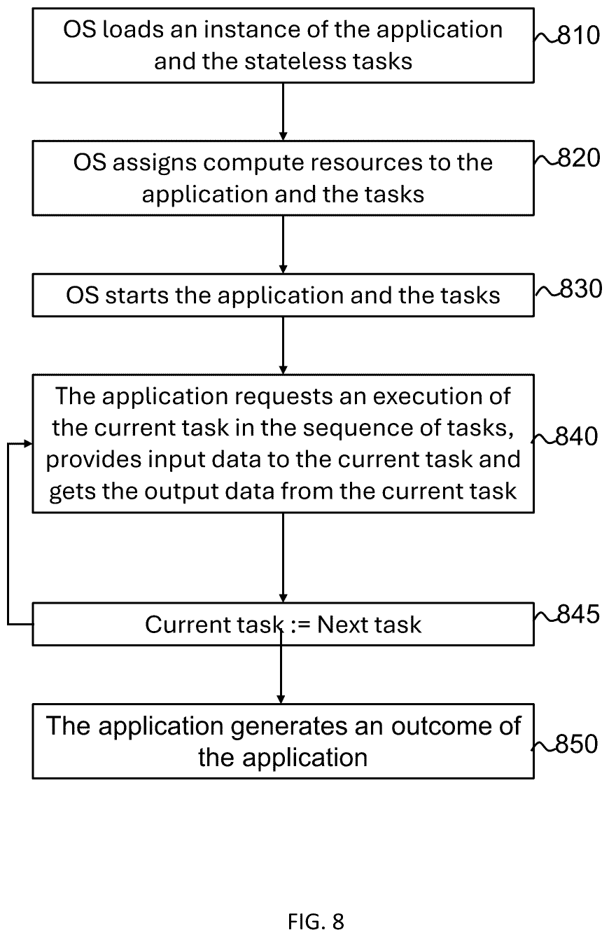

FIG. 8 is a flowchart illustrating a method for executing one or more applications using a plurality of stateless tasks according to an example.

The steps of the method may be implemented by a computing device according to any example described herein.

While the steps are described in a sequential manner, the person skilled in the art will appreciate that some steps may be omitted, combined, performed in different order and/or in parallel.

In step 810, the OS loads in memory instances of the one or more applications and stateless tasks for execution by the computing device. For example, a first application is defined by a temporal sequence of 3 stateless tasks T1, T2, T3 and an instance of the first application and the 3 stateless tasks T1, T2, T3 is loaded.

In step 820, the orchestrator assigns compute resources to the loaded applications and stateless tasks.

In step 830, the OS triggers the execution applications and the tasks. Each of the stateless task waits for input. At this stage, each of the tasks T1, T2, T3 are waiting for execution requests from the applications to execute.

In step 840, the first application A1 triggers the execution of its first task T1 using a first execution request sent to the first task T1. The first application A1 sends application-specific task input data to the first task T1 by inter-process communication. The first application A1 receives application-specific task output data from the first task T1 by inter-process communication after completion of the first task T1.

In step 845, the next task in the temporal sequence, if any, is used as current task and step 840 is repeated for the next task.

For example, step 840 may be repeated with the second task T2: the first application A1 triggers the execution of its second task T2 using a second execution request sent to the second task T2. The first application A1 sends application-specific task input data to the second task T2 by inter-process communication. The application-specific task input data sent to the second task T2 may include the application-specific task output data from the first task T1. The first application A1 receives application-specific task output data from the second task T2 by inter-process communication after completion of the second task T2.

For example, step 840 may be repeated with the third task T3: the first application A1 triggers the execution of its third task T3 using a third execution request sent to the third task T3. The first application A1 sends application-specific task input data to the third task T3 by inter-process communication. The application-specific task input data sent to the third task T3 may include the application-specific task output data from the second task T2. The first application A1 receives application-specific task output data from the third task T3 by inter-process communication after completion of the third task T3.

In step 850, once all tasks in the temporal sequence have been executed, the first application A1 generates an outcome of the first application A1. The first application A1 may for example use the application-specific task output data received from the third task T3 to generate the outcome of the first application A1. This outcome may for example involve sending a notification to a user.

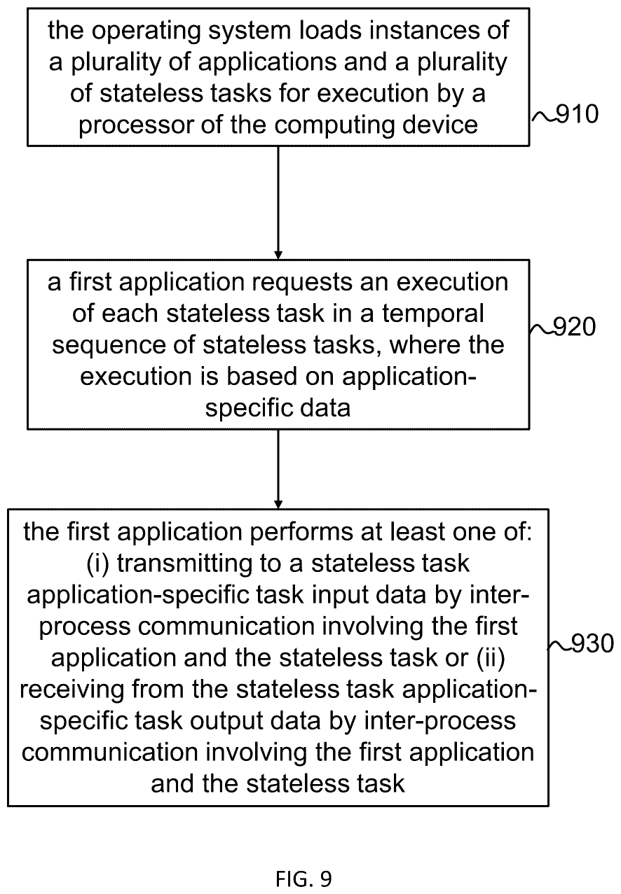

FIG. 9 is a flowchart illustrating a method for executing one or more applications using a plurality of stateless tasks according to an example.

The steps of the method may be implemented by a computing device according to any example described herein. The computing device may be a resource constraint computing device.

While the steps are described in a sequential manner, the person skilled in the art will appreciate that some steps may be omitted, combined, performed in different order and/or in parallel.

In step 910, an operating system of the computing device loads, in at least one memory of the computing device, instances of a plurality of applications and a plurality of stateless tasks for execution by the at least one processor of the computing device.

One or more or each of the plurality of applications is defined based on a temporal sequence of stateless tasks among the plurality of stateless tasks.

The operating system may load only one instance of each of the plurality of stateless tasks.

Each loaded instance of a stateless state is initially in a waiting state, waiting for execution request(s) from one or more application before starting to execute its associated function (e.g., the main function of the task as explained above).

Each loaded instance of a stateless task may be configured to receive and process execution requests from multiple applications and to use the application-specific data for its execution and/or generate application-specific data, without retaining the application-specific data for any next execution of the stateless task.

The operating system may allocate compute resources to the stateless tasks on an as-used basis.

The operating system may allocate respective application-specific memory spaces to the plurality of applications. The application-specific memory space allocated to an application is configured to store application-specific data which are specific to the application.

In step 920, a first application requests an execution of each stateless task in the associated temporal sequence based on application-specific data. For the execution of the first application, at least one of the stateless tasks in the temporal sequence may receive application-specific task input data from the first application and at least one of the stateless tasks may provide application-specific task output data to the first application.

During execution of the applications, the operating system may control execution of the plurality of stateless tasks to prevent concurrent executions of a given stateless task requested by two or more distinct applications. Such control may be done by using a request queue adapted for storing execution requests sent to a given stateless task from any of the applications.

In step 930, the first application performs at least one of: (i) transmitting to at least one stateless task application-specific task input data and/or task parameters by inter-process communication involving the first application and the considered stateless task(s) or (ii) receiving from the at least one stateless task application-specific task output data by inter-process communication involving the first application and the considered stateless task(s). This may be done according to any manner disclosed herein.

For example, the operating system may allocate respective application-specific memory spaces to the plurality of applications where an application-specific memory space which is specific to the application is configured to store the application-specific data and used for inter-process communication with one or more stateless task.

The stateless task may receive, from the application (e.g., by inter-process communication), an address of a portion of the application-specific memory space of the application where the application-specific task input data and/or application-specific task parameter(s) to be used by the stateless task for the execution of the application are stored and the stateless task retrieves the application-specific task input data and/or application-specific task parameters from the portion of the application-specific memory space during its execution.

The stateless may receive, from the application, an address of a portion of the application-specific memory space of the application where the application-specific task output data generated by the stateless task for the execution of the application are to be stored and the stateless task may store the application-specific task output data to the portion of the application-specific memory space during its execution.

A stateless task in the temporal sequence may receive (e.g., by inter-process communication), from the first application, an access key providing access to a portion of the application-specific memory space allocated to the first application, where application-specific data are stored or to be stored. The access key may be used as authentication key to authenticate the considered stateless task and/or as encryption key to decrypt the encrypted data stored in the considered portion of the application-specific memory space.

A stateless task in the temporal sequence may receive (e.g., by inter-process communication), from the first application, an address of a portion of the application-specific memory space of the first application where the input data to be used by the considered stateless task for the execution of the first application are stored.

Steps 920 and 930 may be repeated for another application and/or other stateless tasks in the temporal sequence associated with the first application.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes. Although steps of a method or process may be described in a sequential manner, some of the steps may be performed in parallel, concurrently or simultaneously. Also, some steps may be omitted, combined or performed in different order.

One or more or all operation(s) of a method, process, function, engine, block, step described herein may be implemented in hardware, software, firmware, middleware, microcode, or any suitable combination thereof.

When implemented in software, firmware, middleware or microcode, instructions to perform the considered operation(s) may be stored in a computer readable medium that may be or not included in a computing device (or respectively a computing system) configured to execute the instructions. The instructions may be transmitted over the computer-readable medium and be loaded onto the computing device (or respectively computing system). The instructions are configured to cause the computing device (or respectively computing system) to perform the considered operation(s). For example, as mentioned above, at least one memory may include or store instructions, the at least one memory and the instructions may be configured to, with at least one processor, cause the computing device (or respectively computing system) to perform the considered operation(s).

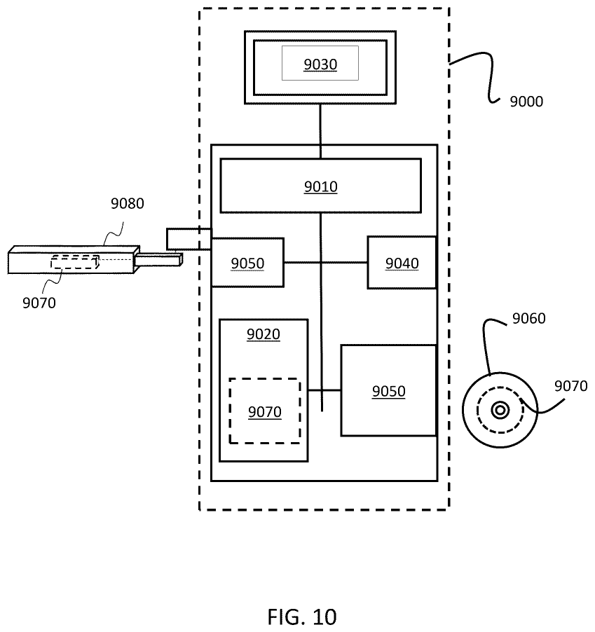

FIG. 10 illustrates an example embodiment of an apparatus (e.g., a computing device) 9000. The computing device 9000 may be configured to perform one or more functions disclosed herein. The computing device 9000 may be configured to perform one or more or all steps of any method disclosed herein.

As represented schematically, the computing device 9000 may include at least one processor 9010 and at least one memory 9020. The computing device 9000 may include one or more communication interfaces 9040 (e.g., network interfaces for access to a wired/wireless network, including Ethernet interface, WIFI interface, etc.) connected to the processor and configured to communicate via wired/non wired communication link(s). The computing device 9000 may include user interface computing devices 9030 (e.g., keyboard, mouse, display screen, etc.) connected with the processor. The computing device 9000 may further include one or more media drives 9050 for reading a computer-readable storage medium (e.g., digital storage disc 9060 (CD-ROM, DVD, Blue Ray, etc.), USB key 9080, etc.). The processor 9010 is connected to each of the other components 9020, 9030, 9040, 9050 in order to control operation thereof.

The memory 9020 may be or include a random-access memory (RAM), cache memory, non-volatile memory, backup memory (e.g., programmable or flash memories), read-only memory (ROM), a hard disk drive (HDD), a solid-state drive (SSD) or any combination thereof. The ROM of the memory 9020 may be configured to store, amongst other things, an operating system of the computing device 9000 and/or one or more computer program code of one or more software applications. The RAM of the memory 9020 may be used by the processor 9010 for the temporary storage of data.

The processor 9010 may be configured to store, read, load, execute and/or otherwise process instructions 9070 stored in a computer-readable storage medium 9060, 9080 and/or in the memory 9020 such that, when the instructions are executed by the processor, causes the computing device 9000 to perform one or more or all steps of a method described herein for the concerned computing device 9000.

The instructions may correspond to program instructions or computer program code. The instructions may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), a Graphical Processing Unit (GPU), an arithmetic logic unit (ALU), a programmable logic unit (PLU), a processing core, a programmable logic, a microprocessor, a controller, a microcontroller, a microcomputer, a quantum processor, any computing device capable of responding to and/or executing instructions in a defined manner and/or according to a logic.

A computer readable medium or computer readable storage medium may be any tangible storage medium suitable for storing instructions readable by a computer or a processor. A computer readable medium may be more generally any storage medium capable of storing and/or containing and/or carrying instructions and/or data. The computer readable medium may be a non-transitory computer readable medium. The term “non-transitory”, as used herein, is a limitation of the medium itself (i.e., tangible, not a signal) as opposed to a limitation on data storage persistency (e.g., RAM vs. ROM).

A computer-readable medium may be a portable or fixed storage medium. A computer readable medium may include one or more storage computing device like a permanent mass storage computing device, magnetic storage medium, optical storage medium, digital storage disc (CD-ROM, DVD, Blue Ray, etc.), USB key or dongle or peripheral, a memory suitable for storing instructions readable by a computer or a processor.

A memory suitable for storing instructions readable by a computer or a processor may be for example: read only memory (ROM), a permanent mass storage computing device such as a disk drive, a hard disk drive (HDD), a solid-state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more computing devices”, “one or more units”, etc.

The means may include at least one processor and at least one memory including at least one memory storing instructions that, when executed by the at least one processor, cause an apparatus to perform the considered function(s). The means may include circuitry (e.g., processing circuitry) configured to perform the considered function(s). The term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together; and

(c) hardware circuit(s) and or processor(s), such as a microprocessor(s) or a portion of a microprocessor(s), that requires software (e.g., firmware) for operation, but the software may not be present when it is not needed for operation.”

As a further example, the term circuitry also covers an implementation of merely a hardware circuit or processor (or multiple processors) or portion of a hardware circuit or processor and its (or their) accompanying software and/or firmware.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, when the term “and/or” is used in a list of items, it implies that the list may include any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It will be appreciated that, as used herein, “at least one of <a list of two or more elements>” and “at least one of the following: <a list of two or more elements>” and similar wording, where the list of two or more elements are joined by “and” or “or”, mean at least any one of the elements, or at least any two or more of the elements, or at least all the elements.

Although aspects have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure as determined based upon the claims and any equivalents thereof.

1. A computing device comprising:
at least one processor;
at least one memory;
an operating system configured to load, in the at least one memory, instances of a plurality of applications and a plurality of stateless tasks for execution by the at least one processor of the computing device;
wherein at least one application of the plurality of applications is defined based on a temporal sequence of stateless tasks and is configured to request an execution of each stateless task in the temporal sequence,
wherein each of the stateless tasks in the temporal sequence is configured to be executed on request from the application based on application-specific data which are transmitted to and/or received from the considered stateless task by inter-process communication involving the application and the stateless task.

2. The computing device of claim 1,
wherein each loaded instance of a stateless task is configured to receive and process execution requests from multiple applications and to use respective application-specific data specific to the requesting application for its execution.

3. The computing device of claim 1,
wherein the operating system is configured to load only one instance of each of the plurality of stateless tasks.

4. The computing device of claim 1,
wherein the operating system is configured to allocate respective application-specific memory spaces to the plurality of applications;
wherein the application-specific data are stored in an application-specific memory space which is specific to the application.

5. The computing device of claim 1,
wherein the operating system is configured to allocate compute resources to the stateless tasks on an as-used basis.

6. The computing device of claim 1,
wherein the operating system is configured to control execution of the plurality of stateless tasks to prevent concurrent executions of a given stateless task requested by two or more distinct applications.

7. The computing device of claim 1,
wherein the operating system is configured to control execution of the plurality of stateless tasks to prevent concurrent execution of a given stateless task requested by two or more applications by using a request queue adapted for storing execution requests sent to the given stateless task by any of the applications.

8. The computing device of claim 1,
wherein, for its execution on request from the application, at least one of the stateless tasks is configured to receive application-specific task input data or application-specific task parameters from the application by inter-process communication.

9. The computing device of claim 1,
wherein, for its execution on request from the application, at least one of the stateless tasks is configured to provide application-specific task output data to the application by inter-process communication.

10. The computing device of claim 1,
wherein a stateless task in the temporal sequence is configured to receive, from the application, an access key providing access to a portion of the application-specific memory space of the application.

11. The computing device of claim 10,
wherein the stateless task is configured to receive, from the application, an address of a portion of the application-specific memory space of the application where the application-specific task input data or application-specific task parameters to be used by the stateless task for the execution of the application are stored,
wherein the stateless task is configured to retrieve the application-specific task input data or application-specific task parameters from the portion of the application-specific memory space during its execution.

12. The computing device of claim 10,
wherein the stateless task is configured to receive, from the application, an address of a portion of the application-specific memory space of the application where the application-specific task output data generated by the stateless task for the execution of the application are to be stored;
wherein the stateless task is configured to store the application-specific task output data to the portion of the application-specific memory space during its execution.

13. The computing device of claim 8, wherein the access key is an authentication key configured to authenticate the stateless task.

14. The computing device of claim 1, wherein the computing device is a resource constrained computing device.

15. The computing device of claim 14, wherein at least two of the plurality of applications each have a same stateless task in their respective temporal sequences.

16. A method for executing a plurality of applications by a computing device, the method comprising:
loading, by an operating system of the computing device, in at least one memory of the computing device, instances of the plurality of applications and a plurality of stateless tasks for execution by the at least one processor of the computing device, wherein at least one of the plurality of applications is defined based on a temporal sequence of stateless tasks among the plurality of stateless tasks;
requesting by the application an execution of each stateless task in the temporal sequence;
performing by the application at least one of: (i) transmitting to at least one stateless task application-specific task input data by inter-process communication involving the at least one stateless task and (ii) receiving from the at least one stateless task application-specific task output data by inter-process communication involving the at least one stateless task, wherein the computing device is a constrained computing device and at least two of the plurality of applications each have a same stateless task in their respective temporal sequences.
